(19) United States
(12) Patent Application Publication
(10) Pub. No.: US 2007/0135185 A1
(43) Pub. Date: Jun. 14, 2007

(54) Modular multifunction speaker and headset

(75) Inventors: Joseph L. Dvorak, Boca Raton, FL (US); Ryan M. Nilsen, Pompano, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc., Schaumburg, IL (US)

(21) Appl. No.: 11/285,274

(22) Filed: Nov. 22, 2005

(51) Int. Cl. H04M 1/00

(52) U.S. Cl. 455/575.2; 455/569.1

(57) ABSTRACT

A wireless communication product (10) can include an electronic host device (12) having a transceiver (13) for wide area communications and a modular peripheral device (30) having a speaker (31), a microphone (33) and a display (37) serving at least as a speaker and a display for the wireless communication product when attached to the electronic host device and the speaker and the microphone serving as a wireless headset and the display serving as an activation button when detached from the electronic host device. The display can serve as a push-to-connect activation when the modular peripheral device is undocked from the electronic host device. The modular peripheral device can include a hook shaped portion (39) formed between the display and the speaker enabling the modular peripheral device to grasp the electronic host device when serving as the speaker or the user's ear when serving as the wireless headset.

### FIELD

This invention relates generally to electronic devices, and more particularly to a modular peripheral device that operates as a speaker or headset based on a docked status to host device.

### BACKGROUND

Wireless headsets such as Bluetooth headsets are very convenient. However, when they are not in use, there is generally no place to put the headset that is unobtrusive. Other modular wireless headsets might include a wearable earpiece and a physically separate microphone. Although these existing devices are modular, they have dedicated functions and become obtrusive when not in use.

### SUMMARY

Embodiments in accordance with the present invention can provide a convenient arrangement or mechanism where a modular multipurpose peripheral can serve as a wireless headset or earpiece as well as a device's own speaker in a manner enabling unobtrusive storage capability of the headset. Such embodiments can also minimize the combined size of the electronic device and earpiece or headset.

In a first embodiment of the present invention, an electronic product can include an electronic host device and at least one modular peripheral device serving as a speaker and a display when docked to the electronic host device and as a headset or as an earpiece when undocked from the electronic host device. The electronic product can be any number of devices

including, but not limit to a cellular phone, a camera phone, a smart phone, a dictation device, or a videophone. The display can further serve as a push-to-connect activation when the modular peripheral device is undocked electronic host device. The modular peripheral device can have a hook shape formed between the display and the speaker enabling the modular peripheral device to grasp the electronic host device when serving as a speaker or grasp the user's ear when serving as a headset. The electronic product can further include magnets for aligning the docking of the modular peripheral device with the electronic host device. The magnets can also serve to provide electrical contact between the at least one modular peripheral device and the electronic host device. The modular peripheral device can be charged (such as trickle charged) from a power source for the electronic host device when the modular peripheral device is docked to the electronic host device. The display can further serve as a send button or end call button when the at least one modular peripheral device is undocked from the electronic host device. A camera can also be integrated with the modular peripheral device or the electronic host device.

In a second embodiment of the present invention, a wireless communication product can include an electronic host device having a transceiver for wide area communications and a modular peripheral device having a speaker, a microphone and a display serving at least as a speaker and a display for the wireless communication product when attached to the electronic host device and the speaker and the microphone serving as a wireless headset and the display serving as an activation button when detached from the electronic host device. The wireless communication product can be a cellular phone, a camera phone, a smart phone, a dictation device, or a videophone for example. The display can serve as a push-to-connect connect activation when the modular peripheral device is undocked from the electronic host device. The modular peripheral device can include a hook shape formed between the display and the speaker enabling the modular peripheral device to grasp the electronic host device when serving as the speaker or the user's ear when serving as the wireless headset. The wireless communication product can further include magnets for aligning the docking of the at least one modular peripheral device with the electronic host device and the magnets can further serve to provide electrical contact between the at least one modular peripheral device and the electronic host device. The modular peripheral device can be charged (such as trickle charged) from a power source for the electronic host device when the at least one modular peripheral device is docked to the electronic host device. Note, function of the electronic host device can be conditioned on a modular peripheral device status as being docked to the electronic host device and function of the modular peripheral device can be conditioned on the modular peripheral device status as being docked to the electronic host device. In one configuration, the wireless communication product can be a cellular phone having a clam shell housing with a flip portion that holds the modular peripheral device.

In a third embodiment of the present invention, a method of changing the functionality of a modular peripheral device and a host device forming a wireless communication product can include the steps of operating the modular peripheral device as a speaker and a display when the modular peripheral device is docked to the host device and operating the modular peripheral device as a wireless headset and enabling the use of the display as a push-to-activate function when the modular peripheral device is undocked from the host device. When the peripheral device is docked to the host device, the method can include the steps of charging a battery in the modular peripheral device or inhibiting the display's function as an activation button. When the peripheral device is undocked to the host device, the method can also include the steps of inhibiting the display's function as a display or operating an integrated speaker and microphone within the modular peripheral device as a wireless headset.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” or “inhibiting” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of an electronic host device in the form of a clam-shell or flip shaped wireless communication device in accordance with an embodiment of the present invention.

FIG. 2 is an illustration of a modular peripheral device that operates with the host device of FIG. 1 in accordance with an embodiment of the present invention

FIG. 3 is a perspective view of the modular peripheral device of FIG. 2 in accordance with an embodiment of the present invention.

FIG. 4 is a perspective view of an electronic product including the electronic host device of FIG. 1 and the modular peripheral device of FIG. 2 in accordance with an embodiment of the present invention.

FIG. 5 is block diagram of an electronic product including a host device and a modular peripheral device in accordance with an embodiment of the present invention.

FIG. 6 is a flow chart illustrating a method of changing the functionality of a modular peripheral device and a host device forming a wireless communication product in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

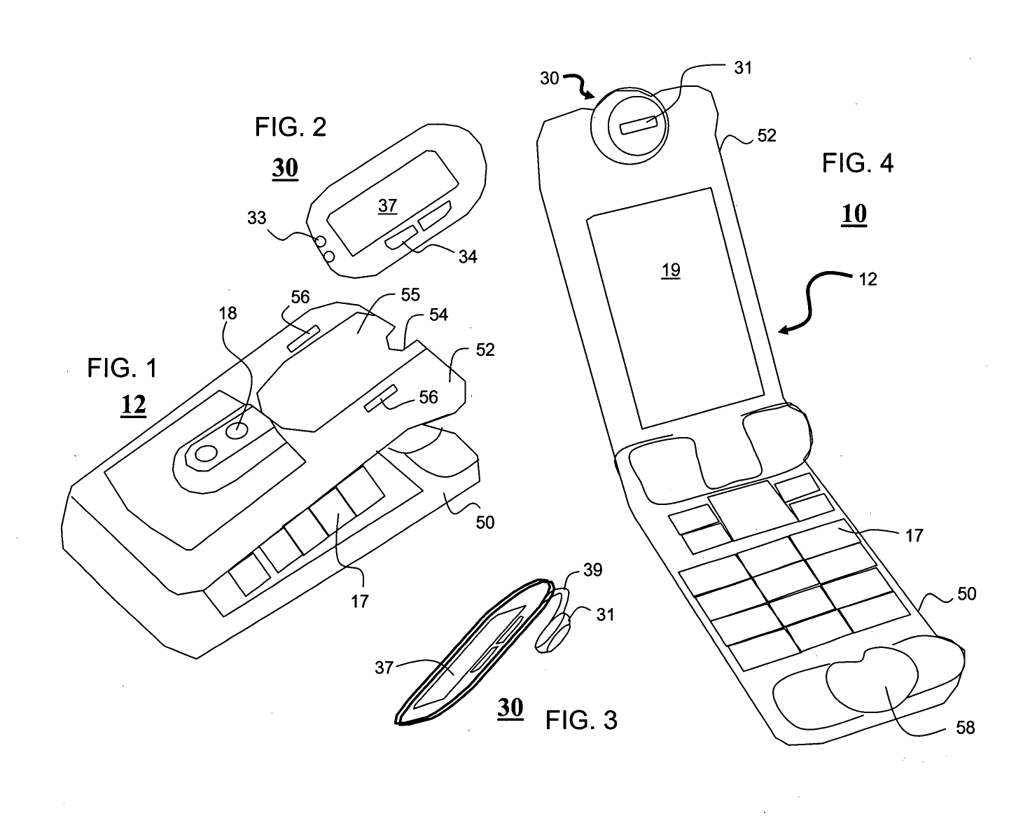

Referring to FIGS. 1-4, an electronic product 10 including an electronic host device 12 and a modular peripheral device 30 is shown. Although the electronic product 10 can take the form of a multitude of products such as a smart phone, a personal digital assistant, a laptop computer, cellular phone, a dictation device, a laptop computer, a personal digital assistant, or a videophone, the particular embodiment illustrated is a cellular phone in a clam-shell or flip phone form factor including a camera. Note that the embodiments herein are not limited to such form factor and can be embodied in a monolith shape or other shape instead of a clam-style shape housing. The modular peripheral device or module 30 can include an integrated speaker 31 and a microphone 33. The module 30 can further include an external display 37 on its external surface and optional user interface devices 34 such as keypads. The main housing of the module 30 encasing the display 37 can be coupled to the speaker 31 via a hook-shaped portion 39 as illustrated in FIG. 3. This hook-shaped portion 39 and/or speaker 31 can be made of a flexible low durometer plastic or rubber to enable the appropriate adjustment within or about a person's ear.

Referring to FIG. 1 and 4, the electronic host device 12 in the form of a clam shell device can include a base housing 50 and a flip portion 52. The base housing 50 can house a user interface 17 in the form of keypads, touch pads, directional keys and the like. The base housing 50 can also include an indentation or cavity 58 that enables the ergonomic mating of the speaker 31 (of the module 30) with the base housing 50 when the flip portion 52 is in a closed position. The flip portion 52 can include a camera 18 and a main display 19. The flip portion 52 can further include features that enable a secure and ergonomic mating or docking with the modular peripheral device or module 30 such as the indentation or cavity 55 that conforms to the bottom shape of the module 30, magnets 56 that provide alignment between the module 30 and the host device 12 and can optionally provide an electrical interconnection there between, and a notch 54 that can accommodate and enable the grasping of the hook-shaped portion 39 of the module 30. Note, the module 30 can include metal contacts (not shown) on a bottom surface of the module 30 to enable the coupling with magnets 56.

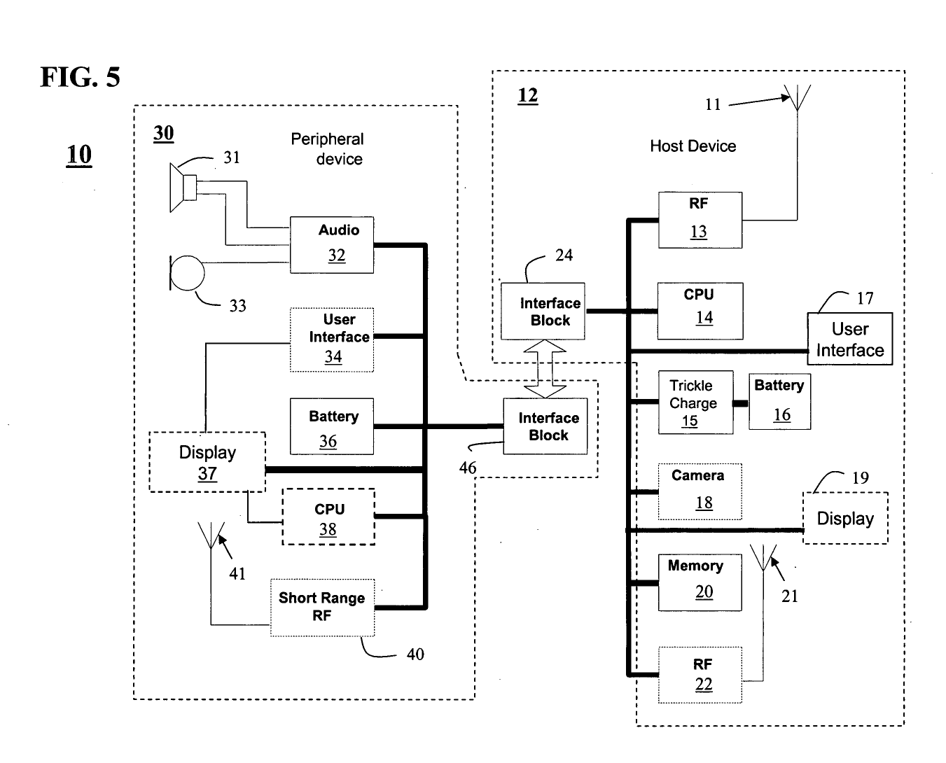

Referring to FIG. 5, a block diagram of the electronic product 10 in the form of a wireless communication product is shown. The product 10 can include the host device 12 and the modular peripheral device 30. The host device 12 can include, for example, a radio frequency (RF) module 13 such as those found in cellular phones, two-way trunked radios, home cordless phones, two-way paging devices, satellite phones, or Motorola iDEN phones, or any number of other communication devices. The RF module can include an encoder, transmitter as well as a receiver and decoder for receiving and decoding information sent to and from the host device 12. The host device 12 can further include an antenna 11, a processor 14 such as a microprocessor and a memory 20. The host device 12 can also include a power source or battery 16, a trickle charger module 15, the user interface 17 (such as keypads), a presentation device such as the display 19 and a short range transceiver 22 and antenna 21 such as a Bluetooth module or other suitable short range communication module to enable the hands free or wireless operation of the peripheral device 30 when undocked. The display can be coupled to a graphical user interface program or driver (not shown). The host device 12 can further include an interface block 24 (which may connect directly to the peripheral device 30 either by direct contact attachment using contacts or the magnets 56 (see FIG. 1), or wirelessly, or inductively).

The peripheral device 30 can include a power source 36 such as a battery, the user interface 34, a processor or CPU 38, and a second interface block 46 for interfacing with the interface block 24 of the host device 12. The interface blocks 24 and 46 can connect to each other by direct contact, wirelessly or in any other manner. As discussed above, this embodiment can enable a direct physical connection of the host and peripheral device and can optionally include data signal interfacing if desired. The peripheral device 30 can include a presentation and/or input device such as an audio module 32 coupled to speaker 31 and microphone 33. The peripheral device 30 can further include a display 37. The peripheral device 30 can also include an short range communication module 40 and antenna 41 for communicating with module 22 of the host device 12.

The electronic host device 12 and the modular peripheral device 30 can each be programmed to operate in a particular manner based on several conditions. For example, the behavior of the phone or host device 12 can be conditioned on whether or not the peripheral module 30 is physically connected to the host device 12. For example, the effect of closing of the phone's cover (when the host device is embodied as a flip phone) may differ based on whether or not the peripheral module 30 is docked to the host device 12. The function of the peripheral device 30 can also be conditioned on whether or not the module is physically attached to the phone or host device. When the peripheral module is detached from the phone and is operating as the wireless earpiece, the phone's cover (if it is a flip phone) can be closed without terminating the call. When the module is docked with the phone and is functioning as the phone's integrated speaker, closing a flip phone's cover will terminate the call as is normal practice in a flip phone. Removing the module from the phone without opening the cover (if it is a flip phone) activates the module as the phone's wireless earpiece.

The peripheral device 30 or audio module has an external area with two context dependent functions. When the module is docked and is functioning as the phone's integrated speaker, the external area's function as an external phone display is activated and its function as a button is inhibited. When the module is undocked and acting as the phone's wireless earpiece, the external display function of the area is inhibited and the button function is activated for PTT/on-hook/off-hook actions corresponding to presses of different duration. Conditioning both the phone's behavior and the audio module's behavior on whether or not the module is physically connected to the phone increases the synergy between the units and provides a more compelling user experience. The context dependent functions of the audio module's external area are just a few examples.

As noted above, the speaker 31 of the modular peripheral device 30 can serve as a modular earpiece for a headset when undocked and a speaker for the host device when docked. Furthermore, the display 37 on an opposing side of the speaker 31 can serve as a Caller ID display when the headset (peripheral device 30) is docked and as a push-to-activate (PTx) or push-to-connect, or push-to-talk (PTT) button when being worn by a user. The headset or peripheral device 30 is cleverly designed with a “hook” shaped portion 39 to accommodate both the earpiece (31) and the display 37. The speaker 31 and display 37 both having dual functions in this embodiment, namely an earpiece/speaker and a Caller ID display/PTT button. Despite the dual functionality of these devices, the embodiment shown does not affect the width of the phone very much.

If the specific embodiment illustrated is a cell phone, then docking of the peripheral module 30 or audio module with a cell phone causes the speaker 31 to become the cell phone's integrated speaker. The cell phone with the speaker 31 attached can be in every way the same as the cell phone with a traditional, integrated speaker. When the peripheral module undocks, the peripheral module becomes a wireless earpiece that communicates with the phone. To preserve the battery life of the audio module when undocked from the phone and functioning as the phone's wireless earpiece, the phone can detect when the module is securely docked or undocked with the phone. When docked and when the wireless connection between the host device or phone and the peripheral module is severed, the module's wireless circuitry can be shut down. Furthermore, trickle charging from the host to the peripheral can commence as needed. As a result of a detected physical connection between the phone's audio circuitry and the peripheral module, the speaker 31 of the module 30 can now function as the phone's integrated speaker.

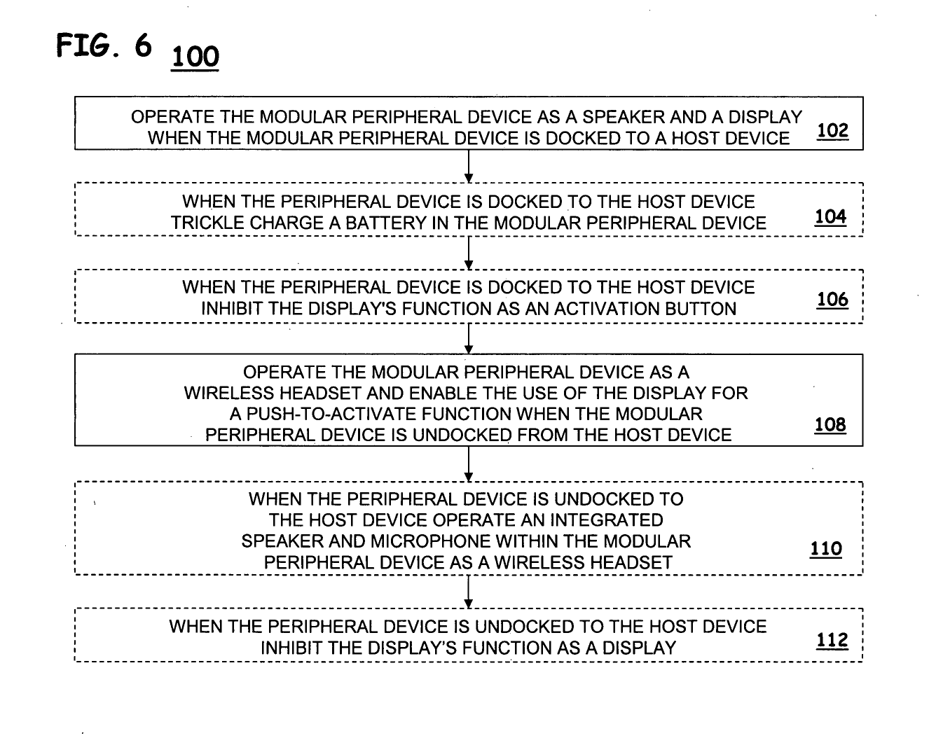

Referring to FIG. 6, a flow chart illustrating a method 100 of changing the functionality of a modular peripheral device and a host device forming a wireless communication product includes the step 102 of operating the modular peripheral device as a speaker and a display when the modular peripheral device is docked to the host device and the step 108 of operating the modular peripheral device as a wireless headset and enabling the use of the display as a push-to-activate function when the modular peripheral device is undocked from the host device. When the peripheral device is docked to the host device, the method 100 can include the step 104 of charging (such as trickle charging) a battery in the modular peripheral device and/or the step 106 of inhibiting the display's function as an activation button. When the peripheral device is undocked to the host device, the method 100 can also include the step 110 of operating an integrated speaker and microphone within the modular peripheral device as a wireless headset and/or the step 112 of inhibiting the display's function as a display.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in. any way, except as set forth in the following claims.

What is claimed is:

1. An electronic product, comprising:
an electronic host device; and
at least one modular peripheral device serving as a speaker and a display when docked to the electronic host device and as a headset or as an earpiece when undocked from the electronic host device.

2. The electronic product of claim 1, wherein the display further serves as a push-to-connect activation when the at least one modular peripheral device is undocked from the electronic host device.

3. The electronic product of claim 1, wherein the at least one modular peripheral device further comprises a hook shape formed between the display and the speaker enabling at least one modular peripheral device to grasp the electronic host device when serving as a speaker or the user's ear when serving as a headset.

4. The electronic product of claim 1, wherein the electronic product further comprises magnets for aligning the docking of the at least one modular peripheral device with the electronic host device.

5. The electronic product of claim 4, wherein the magnets further serve to provide electrical contact between the at least one modular peripheral device and the electronic host device.

6. The electronic product of claim 1, wherein the at least one modular peripheral device is charged from a power source for the electronic host device when the at least one modular peripheral device is docked to the electronic host device.

7. The electronic product of claim 1, wherein the display further serves as a send button or end call button when the at least one modular peripheral device is undocked from the electronic host device.

8. The electronic product of claim 1, wherein a camera is integrated with the at least one modular peripheral device or the electronic host device.

9. The electronic product of claim 1, wherein the electronic product comprises a cellular phone, a camera phone, a smart phone, a dictation device, a laptop computer, a personal digital assistant, or a videophone.

10. A wireless communication product, comprising:
an electronic host device having a transceiver for wide area communications; and
a modular peripheral device having a speaker, a microphone and a display serving at least as a speaker and a display for the wireless communication product when attached to the electronic host device and the speaker and the microphone serving as a wireless headset and the display serving as an activation button when detached from the electronic host device.

11. The wireless communication product of claim 10, wherein the wireless communication product comprises a cellular phone, a camera phone, a smart phone, a dictation device, a laptop computer, a personal digital assistant, or a videophone.

12. The wireless communication product of claim 10, wherein the display serves as a push-to-connect activation when the modular peripheral device is undocked from the electronic host device.

13. The wireless communication product of claim 10, wherein the modular peripheral device further comprises a hook shape formed between the display and the speaker enabling the modular peripheral device to grasp the electronic host device when serving as the speaker or the user's ear when serving as the wireless headset.

14. The wireless communication product of claim 10, wherein the wireless communication product further comprises magnets for aligning the docking of the at least one modular peripheral device with the electronic host device.

15. The wireless communication product of claim 14, wherein the magnets further serve to provide electrical contact between the at least one modular peripheral device and the electronic host device.

16. The wireless communication product of claim 10, wherein the modular peripheral device is charged from a power source for the electronic host device when the at least one modular peripheral device is docked to the electronic host device.

17. The wireless communication product of claim 10, wherein function of the electronic host device is conditioned on a modular peripheral device status as being docked to the electronic host device and function of the modular peripheral device is conditioned on the modular peripheral device status as being docked to the electronic host device.

18. The wireless communication product of claim 10, wherein the wireless communication product is a cellular phone having a clam shell housing with a flip portion that holds the modular peripheral device.

19. A method of changing the functionality of a modular peripheral device and a host device forming a wireless communication product, comprising the steps of:
operating the modular peripheral device as a speaker and a display when the modular peripheral device is docked to the host device; and
operating the modular peripheral device as a wireless headset and enabling the use of the display as a push-to-activate function when the modular peripheral device is undocked from the host device.

20. The method of claim 19, wherein the method further comprises at least one among the steps when the peripheral device is docked to the host device of charging a battery in the modular peripheral device or inhibiting the display's function as an activation button or among the steps when the peripheral device is undocked to the host device of inhibiting the display's function as a display or operating an integrated speaker and microphone within the modular peripheral device as a wireless headset.
